(19) United States
(12) Patent Application Publication
(10) Pub. No.: US 2015/0076719 A1
(43) Pub. Date: Mar. 19, 2015

(54) METHOD OF MANUFACTURING POLYMER FILM AND POLYMER FILM STRETCHING APPARATUS THEREFOR

(71) Applicant: SAMSUNG ELECTRONICS CO., LTD., Suwon-si (KR)

(72) Inventors: Chan Jae Ahn, Seoul (KR); Sung Won CHOI, Hwaseong-si (KR); Won Suk CHANG, Hwaseong-si (KR)

(21) Appl. No.: 14/451,806

(22) Filed: Aug. 5, 2014

(30) Foreign Application Priority Data
Aug. 9, 2013 (KR) 10-2013-0094904
Aug. 9, 2013 (KR) 10-2013-0094971

(51) Int. Cl. B29C 47/00; B29C 47/88; B29C 55/14

(52) U.S. Cl. CPC B29C 47/0057; B29C 55/143; B29C 47/8805; B29K 2079/08
USPC 264/1.6; 264/210.6; 425/66

(57) ABSTRACT

A method of manufacturing a polyimide film includes: extruding a polyimide film including polyimide and a solvent; first drying the extruded polyimide film; stripping the first-dried polyimide film; second drying the stripped polyimide film to remove a residual solvent in the polyimide film; and stretching the second-dried polyimide film, wherein an amount of the residual solvent in the second-dried polyimide film is equal to or less than about 10 weight percent.

### CROSS-REFERENCE TO RELATED APPLICATION

This application claims priority to Korean Patent Application No. 10-2013-0094904, filed on Aug. 9, 2013, and all the benefits accruing therefrom under 35 U.S.C. §119, the content of which in its entirety is herein incorporated by reference.

### BACKGROUND

(a) Field

This application relates to a method of manufacturing a polymer film and an apparatus for stretching the polymer film.

(b) Description of the Related Art

A polymer substrate, such as a plastic substrate, is being developed for flexible display devices. A substrate may suffer from high temperature processes, and thus heat-resistant polymers, such as polyimides, are strong candidates for a substrate.

However, the optical phase retardation of the polyimide film may be sensitive to external forces, for example from deformation due to the external forces. Therefore, it is difficult to maintain a low value of the retardation of the polyimide film during the stretching and dry processes for manufacturing the film, and a deviation of the retardation may be relatively large. Since high values of the optical phase retardation and the deviation thereof may distort light, a substrate having a high retardation value and a high retardation deviation may not be suitable for a substrate for a display device. Thus the remains a need for improved methods of manufacturing polymeric films.

### SUMMARY

A method of manufacturing a polyimide film includes: extruding a polyimide film including a polyimide and a solvent; first drying the extruded polyimide film; stripping the first-dried polyimide film; second drying the stripped polyimide film to remove a residual solvent in the polyimide film; and stretching the second-dried polyimide film, wherein an amount of the residual solvent in the second-dried polyimide film is equal to or less than about 10 weight percent (wt %).

The amount of the residual solvent in the second-dried polyimide film may be equal to or less than about 5 wt %.

The second drying may include: stretching the second-dried polyimide film in a first, e.g., width, direction, and stretching the stripped polyimide film in a second, e.g., length, direction.

A stretching ratio of the stretching in the second direction may range from about 0.95 to about 1.0.

The stretching ratio of the stretching in the second direction may range from about 0.965 to about 0.995.

A temperature in the second drying may be greater than a maximum temperature in the first drying and less than a maximum temperature in the stretching.

The maximum temperature in the first drying may range from about 100° C. to about 220° C., the temperature in the second drying may range from about 150° C. to about 250° C., and the maximum temperature in the stretching may range from about 200° C. to about 400° C.

An amount of a residual solvent in the first dried polyimide film may range from about 15 wt % to about 30 wt %.

The method may further include: third drying the stretched polyimide film.

A value of an optical phase retardation of the stretched polyimide film may be equal to or less than about 10 nm, and a deviation of the optical phase retardation of the stretched polyimide film may be equal to or less than about 10 nm.

A method of manufacturing a polyimide film according to an embodiment includes: extruding a polyimide film including a polyimide and a solvent; first drying the extruded polyimide film; stripping the first-dried polyimide film; second drying the stripped polyimide film to remove a residual solvent in the polyimide film; and stretching the second-dried polyimide film in a first direction, wherein the second drying includes: stretching the stripped polyimide film in a second direction, a stretching ratio of the stretching in the second direction may range from about 0.95 to about 1.0, and an amount of the residual solvent in the second-dried polyimide film is equal to or less than about 12 weight percent.

The stretching ratio of the stretching in the second, e.g. length, direction may range from about 0.965 to about 0.995.

A temperature in the second drying may be greater than a maximum temperature in the first drying and less than a maximum temperature in the stretching.

The maximum temperature in the first drying may range from about 100° C. to about 220° C., the temperature in the second drying may range from about 150° C. to about 250° C., and the maximum temperature in the stretching may range from about 200° C. to about 400° C.

An amount of a residual solvent in the first dried polyimide film may range from about 15 weight percent (wt %) to about 30 wt %.

The method may further include: third drying the stretched polyimide film.

A value of an optical phase retardation of the stretched polyimide film may be equal to or less than about 10 nm, and a deviation of the optical phase retardation of the stretched polyimide film may be equal to or less than about 10 nm.

An apparatus for stretching a polymer film according to an embodiment includes: a first dryer configured to dispose a polymer film on a belt, to dry the polymer film, and to strip the polymer film from the belt; a second dryer configured to re-dry the polymer film from the first dryer to reduce an amount of a residual solvent in the polymer film; and a stretching unit configured to stretch the polymer film from the second dryer in a width direction of the polymer film.

The second dryer may include: a first zone including a plurality of first rollers configured to move the polymer film; a second zone adjacent to the first zone; and a third zone adjacent to the second zone and including a plurality of second rollers configured to move the polymer film, wherein the polymer film passes through the first zone, the second zone, and the third zone in sequence.

The first rollers may be arranged in a zigzag in the first zone, and the second rollers may be arranged in a zigzag in the third zone.

The first rollers may include: a plurality of rotatable driving rollers arranged in a vertical direction; and a plurality of idle rollers spaced apart from the driving rollers in a horizontal direction, arranged in the vertical direction, and having vertical positions different from vertical positions of the driving rollers, and wherein the polymer film passes through the driving rollers and the idle rollers in an alternate manner to move in a vertical direction.

The driving rollers may include: a first driving roller; and a second driving roller preceding the first driving roller in a proceeding direction of the polymer film, wherein a rotating speed of the second driving roller may be less than a rotating speed of the first driving roller.

The second zone may include a moving roller configured to move in a vertical direction, the polymer film may include an extra portion drooping in the second zone, the extra portion of the polymer film contacting a bottom surface of the moving roller and pressed by a weight of the moving roller, and the moving roller moves in the vertical direction based on a length of the extra portion of the polymer film.

The second zone may further include a sensor configured to detect a vertical position of the moving roller.

A minimum distance between two adjacent first rollers in a proceeding direction of the polymer film may be equal to or less than about 10 cm.

The apparatus may further include a third dryer configured to dry the polymer film from the stretching unit to evaporate the residual solvent in the polymer film.

The apparatus may further include a thickness gauge configured to measure a thickness of the polymer film from the stretching unit.

The stretching unit may include a tenter.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a flow chart illustrating an embodiment of a method of manufacturing a polymer film, for example, a polyimide film;

FIG. 2 is a schematic view of an embodiment of an apparatus for stretching a polymer film;

FIG. 3 is a schematic view of an embodiment of a first dryer in the apparatus of stretching a polymer film;

FIG. 4 illustrates an embodiment of a stretching method in a tenter in the apparatus of stretching a polymer film;

FIG. 5 is a schematic view of an embodiment of an apparatus for stretching a polymer film;

FIG. 6 is a schematic front view of an embodiment of a second dryer in the apparatus of stretching a polymer film;

FIG. 7 and FIG. 8 are schematic diagrams illustrating an embodiment of a structure and operation of rollers in a first zone of the second dryer; and

FIG. 9 to FIG. 12 are schematic diagrams illustrating operation of a moving roller in the second dryer.

### DETAILED DESCRIPTION OF THE EMBODIMENTS

Aspects of one or more of the embodiments will be described more fully hereinafter with reference to the accompanying drawings. As those skilled in the art would realize, the described embodiments may be modified in various different ways, all without departing from the spirit or scope of this disclosure. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

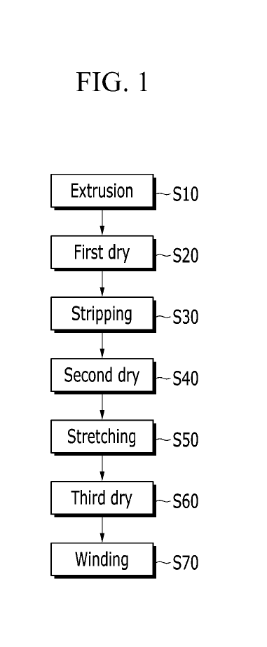

A method of manufacturing a polymer film, for example, a polyimide film according to an embodiment is described in detail with reference to FIG. 1.

FIG. 1 is a flow chart illustrating an embodiment of a method of manufacturing a polymer film, for example, a polyimide film.

Referring to FIG. 1, a polyimide film according to an embodiment may be manufactured by a method comprising extrusion, first dry, stripping, second dry, stretching, and third dry. The processes may be performed by using belts and rollers.

First, a flexible polyimide film (not shown) including a solvent may be extruded on a support (not shown) (S10).

The polyimide film may include polyimide and a solvent, and examples of the solvent may include N-methyl-2-pyrrolidone (NMP) and dimethylacetamide (DMAc), for example. Since the freshly-extruded polyimide film may include an abundant amount of the solvent and thus may not support itself in a form of a film, the polyimide film may be placed on the support. The polyimide film extruded on the support may be disposed on, e.g., attached to, the support, and the support may be a moving belt.

Next, the extruded polyimide film may be firstly dried (S20). The first dry may remove, e.g., evaporate, the solvent so that the polyimide film may be self-supporting.

The drying temperature in the first dry may be increased stepwise, and then may be decreased stepwise. According to an embodiment, the first dry may be divided into five steps, for example, the drying temperature in the first step may be about 50° C. to about 100° C., the drying temperature in the second step may be about 70° C. to about 120° C., the drying temperature in the third step may be about 100° C. to about 200° C., the drying temperature in the fourth step may be about 70° C. to about 120° C., and the drying temperature in the fifth step may be about 50° C. to about 100° C. The temperature in the fourth step may be substantially the same as the temperature in the second step, and the temperature in the fifth step may be substantially the same as the temperature in the first step. The stepwise division of the first dry may be implemented by partitioning an interior of a dryer used in the first dry.

The first dry may be performed by convection heating, e.g., hot air, or infrared heating, however, the drying method is not limited thereto. The degree of the removal, e.g., evaporation, of the solvent may be different depending on the method of the drying, and thus the drying temperature of the first dry may be different for different drying methods.

The residual amount of the solvent in the polyimide film after the first dry may be about 15 wt % to about 30 wt %. The residual amount of the solvent is the weight of the solvent divided by the total weight of the polyimide film, in percent. This definition of the residual amount of the solvent will be used hereinafter. When the residual amount of the solvent is less than about 15 wt %, it may be difficult to strip the polyimide film from the support in a later process. When the residual amount of the solvent is greater than about 30 wt %, the polyimide film may not sustain its form by itself.

Next, the polyimide film, after the first dry, may be stripped from the support (S30). The stripped polyimide film may be moved by rollers.

Subsequently, the stripped polyimide film may be subjected to a second dry (S40).

The second dry may further remove, e.g., evaporate, the solvent that is still included in the polyimide film after the first dry. The temperature of the second dry may be greater than the maximum temperature of the first dry. In the above-described example including the five steps in the first dry, a maximum temperature of the second dry may be greater than the temperature of the third step that is the greatest in the first dry. For example, the maximum temperature of the second dry may be about 150° C. to about 250° C.

The second dry may be performed using convection, e.g., hot air, or infrared heating, like the first dry, and the drying temperature of the second dry may be different depending on drying methods.

The polyimide film may be stretched in a proceeding direction in a degree during the second dry. According to an embodiment, the stretching ratio may be about 0.95 to about 1.00, for example, 0.965 to about 0.995. The stretching ratio is defined by a proceeding speed of the film after the second dry divided by a proceeding speed of the film entering into the second dry.

According to an embodiment, the residual amount of the solvent in the polyimide film after the second dry may be equal to or less than about 10 wt %, for example, equal to or less than about 5 wt %. However, when the stretching ratio ranges from about 0.95 to about 1.00, the residual amount of the solvent in the polyimide film after the second dry may be equal to or less than about 12 wt %.

The above-described processes may reduce the optical retardation value and the deviation of the retardation value of the polyimide film after the stretching. For example, the optical retardation value may be equal to or smaller than about 10 nanometers (nm), and the deviation may be equal to or smaller about 10 nm.

Next, the polyimide film after experiencing the second dry may be stretched (S50).

A stretching direction may be substantially parallel to a first, e.g., width, direction of the polyimide film, or substantially perpendicular to a proceeding direction of the polyimide film. A tenter may be used in the stretching.

A maximum temperature in the stretching may be greater than the temperatures of the first dry and the second dry. According to an embodiment, the stretching temperature may be raised in a stepwise manner. For example, a first step may be about 100° C. to about 200° C., a second step may be about 200° C. to about 300° C., and a third step may be about 200° C. to about 400° C.

Convection or infrared heating may be used in heating during the stretching, and the stretching temperature may be different depending on heating methods.

Subsequently, the stretched polyimide film may be subjected to the third dry (S60) such that the solvent in the polyimide film may be evaporated as much as possible.

The temperature of the third dry may be greater than the temperatures in the first dry, the second dry, and the stretching, and may be about 100° C. to about 400° C., for example. Convection or infrared heating may be used for heating during the third dry like the first dry, the second dry, and the stretching, and the temperature in the third dry may be different depending on heating method.

The film after the third dry may be ready to be used, and the film after the third dry may be rolled into a roll (S70).

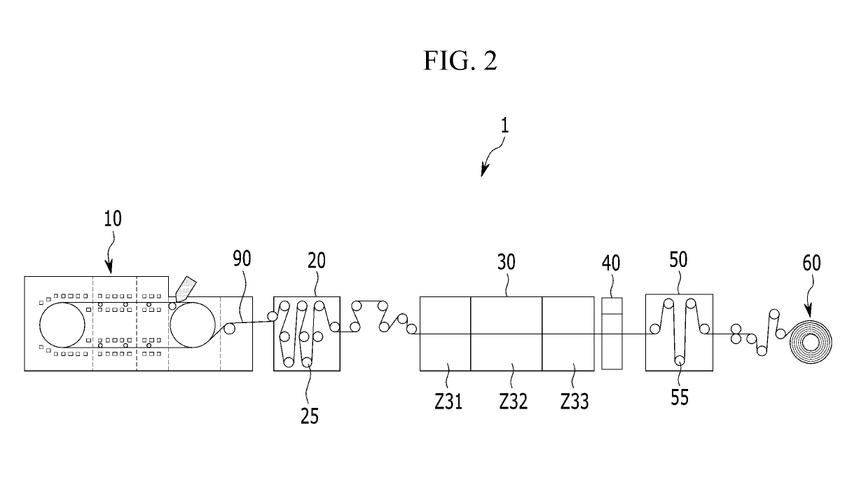

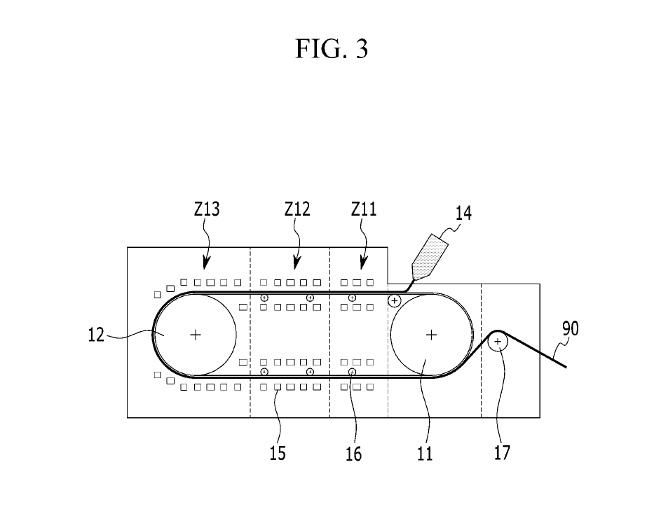

An apparatus of stretching a polymer film and a stretching method using the apparatus according to embodiments is described in further detail with reference to FIG. 2 and FIG. 3.

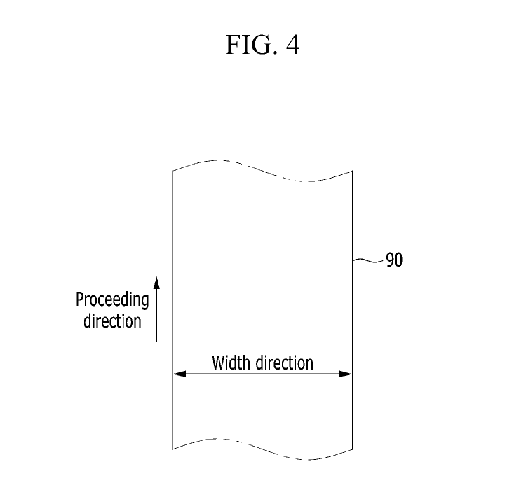

FIG. 2 is a schematic view of an embodiment of an apparatus for stretching a polymer film, FIG. 3 is a schematic view of an embodiment of a first dryer in the apparatus of stretching a polymer film, and FIG. 4 illustrates a stretching method in an embodiment of a tenter in the apparatus of stretching a polymer film.

Referring to FIG. 2, an apparatus 1 for stretching a polymer film according to an embodiment may include a first dryer 10, a second dryer 20, a tenter 30, a thickness gauge 40, a third dryer 50, and a winder 60, which are arranged in series.

A flexible polymer film, for example, a polyimide film 90, may be extruded, firstly-dried, and stripped in the first dryer 10, may be secondly-dried in the second dryer 20 such that a residual amount of a solvent in the polyimide film 90 may be greatly reduced, may be stretched in a first, e.g., width, direction in the tenter 30, may be lastly-dried in the third dryer 50, and finally may be rolled around the winder 60.

The first dryer 10 may extrude the polyimide film 90, may firstly dry the polyimide film 90 to evaporate the solvent in the polyimide film 90 in a degree such that the polyimide film may be self-supporting, and then may strip off the polyimide film 90. Referring to FIG. 3, the first dryer 10 may include a pair of first and second cylindrical pulleys 11 and 12, a belt 13, a film extruder 14, a plurality of air-spraying nozzles 15, a plurality of belt supporting rollers 16, and a film supporting roller 17.

Each of the pulleys 11 and 12 may be somewhat cylindrical and may be configured to rotate around a rotational axis substantially parallel to a horizontal plane. The pulleys 11 and 12 may be spaced apart from each other, and the rotational axes thereof may be substantially parallel to each other. Diameters of the pulleys 11 and 12 may be substantially the same.

The pulleys 11 and 12 may be coupled via the belt 13, and the belt 13 may be configured to rotate based on the rotations of the pulleys 11 and 12. A portion of the belt 13 located between the pulleys 11 and 12 may be substantially horizontal. A material for the belt 13 may include stainless steel, for example.

The film extruder 14 may be disposed adjacent the belt 13 near the first pulley 11, and may extrude the polyimide film 90 to be disposed, e.g., attached, onto the belt 13. An example of the film extruder 14 may include a T-die.

The air-spraying nozzles 15 may be disposed above and below the belt 13, along the belt 13, and may spray hot air.

The belt supporting rollers 16 may support the belt 13 such that the belt 13 may not be deformed or may not droop.

The film supporting roller 17 may support the polyimide film 90.

In the first dryer 10, a region from a front of the first pulley 11 to the second pulley 12 may be divided into three zones, Z11, Z12, and Z13 having different temperatures. The temperatures of the zones Z11, Z12, and Z13 may increase from the first pulley 11 to the second pulley 12. In detail, the first zone Z11 that is the closest to the first pulley 11 has a lowest temperature, the third zone Z13 including the second pulley 12 therein has a highest temperature, and the temperature of the second zone Z12 may be intermediate. For example, the temperature of the first zone Z11 may be about 50° C. to about 100° C., the temperature of the second zone Z12 may be about 70° C. to about 120° C., and the temperature of the third zone Z13 may be about 100° C. to about 200° C.

The air-spraying nozzles 15 and the belt supporting rolls 16 may be disposed in the first to third zones Z11, Z12, and Z13.

A temperature exterior to the first to third zones Z11, Z12, and Z13 may be a room temperature.

Operations of the first dryer 10 are now further described.

The belt 13 may move as the first and second pulleys 11 and 12 rotate, and the film extruder 14 near the first pulley 11 may extrude the flexible polyimide film 90 onto the belt 13. The polyimide film 90 may include an abundant amount of the solvent and thus may not support itself in a form of a film.

The polyimide film 90 may ride on the belt 13 into the first zone Z11, may pass through the second zone Z12, and may reach the third zone Z13. In the third zone Z13, the polyimide film 90 on the belt 13 may rotate along a circumferential surface of the second pulley 12, and may be reversed to face downward. The reversed polyimide film 90 may start from the third zone Z13 and may return to the first zone Z11 via the second zone Z12.

The polyimide film 90, while passing through the first to third zones Z11, Z12, and Z13, may be exposed to hot air sprayed by the air-spraying nozzles 15 arranged above and below the belt 13. Then, the solvent included in the polyimide film 90 may be evaporated such that the polyimide film 90 may be self-supporting.

The polyimide film 90 on the belt 13, after escaping the first zone Z11 may move along a circumference of the first pulley 11. In this step, the polyimide film 90 may be stripped from the belt 13 and may move toward the film supporting roller 17. Thereafter, the polyimide film 90 may escape from the first dryer 10 to move toward the second dryer 20.

A residual amount of the solvent in the polyimide film 90 may remain because the stripping of the polyimide film 90 from the belt 13 may be difficult when the amount of the solvent to be evaporated is excessive. Therefore, the dry of the polyimide film 90 in the first dryer 10 may be performed in order that the polyimide film 90 may be self-supporting and may include a sufficient amount of the residual solvent for stripping.

Referring to FIG. 2 again, the second dryer 20 may include a plurality of rollers 25, and the polyimide film 90 may move in a zigzag along the rollers 25. The second dryer 20 may evaporate most of the residual solvent in the stripped polyimide film 90 after the first dry. In this process, the polyimide film may be stretched in a proceeding direction of the polyimide film 90 in a degree by adjusting the rotational speed of the rollers 25. According to an embodiment, the stretching ratio may be about 0.95 to about 1.00, for example, 0.965 to about 0.995. The stretching ratio is defined by a proceeding speed of the film 90 going out of the second dryer 20 divided by a proceeding speed of the film 90 entering into the second dryer 20.

According to an embodiment, the residual amount of the solvent in the polyimide film 90 after passing through the second dryer 20 may be equal to or less than about 10 wt %, for example, equal to or less than about 5 wt %. However, when the stretching ratio ranges from about 0.95 to about 1.00, the residual amount of the solvent in the polyimide film 90 after the second dry may be equal to or less than about 12 wt %.

Referring to FIG. 4, the tenter 30 may stretch the polyimide film 90 in a first, e.g., width, direction substantially perpendicular to the proceeding direction. Referring to FIG. 3 again, the tenter 30 may be divided into three zones Z31, Z32, and Z33 having different temperatures. The temperatures of the zones Z31, Z32, and Z33 may increase as proceeding along the proceeding direction of the polyimide film 90. For example, T1≦T2≦T3 and T1<T3 when the temperature of the first zone Z31 is denoted by T1, the temperature of the second zone Z32 is denoted by T2, and the temperature of the third zone Z33 is denoted by T3.

According to an embodiment, the temperature in each of the zones Z31, Z32, and Z33 may be uniform. For example, the temperature in the first zone Z31 may be about 100° C. to about 200° C., the temperature in the second zone Z32 may be about 200° C. to about 300° C., and the temperature in the third zone Z33 may be about 200° C. to about 400° C.

When the tenter 30 stretches the polyimide film 90, the polyimide film 90 including more solvent may be more stretched than one including less solvent, and the stretched amount of the polyimide film 90 including more solvent may be more deviated than one including less solvent under the same stretching force such that the in-plane retardation of the polyimide film 90 including more solvent and the deviation thereof may become larger. Therefore, the solvent evaporation in the second dryer 20 disposed between the first dryer 10 and the tenter 30 may be performed such that the residual solvent in the polyimide film 90 may be equal to or less than a predetermined value, for example, equal to or less than about 10 wt %, or equal to or less than about 5 w %. In this way, the second dryer 20 may increase the evaporated amount of the solvent to reduce the residual solvent.

The thickness gauge 40 may measure a thickness of the polyimide film 90 out of the tenter 30. The thickness gauge 40 may be omitted.

The third dryer 50 may include a plurality of rollers 55, and may anneal the polyimide film 90 using infrared heating, for example, to lastly dry the stretched polyimide film 90. The annealing temperature may range from about 100° C. to about 400° C.

The winder 60 may roll the fully-dried polyimide film 90 into a roll.

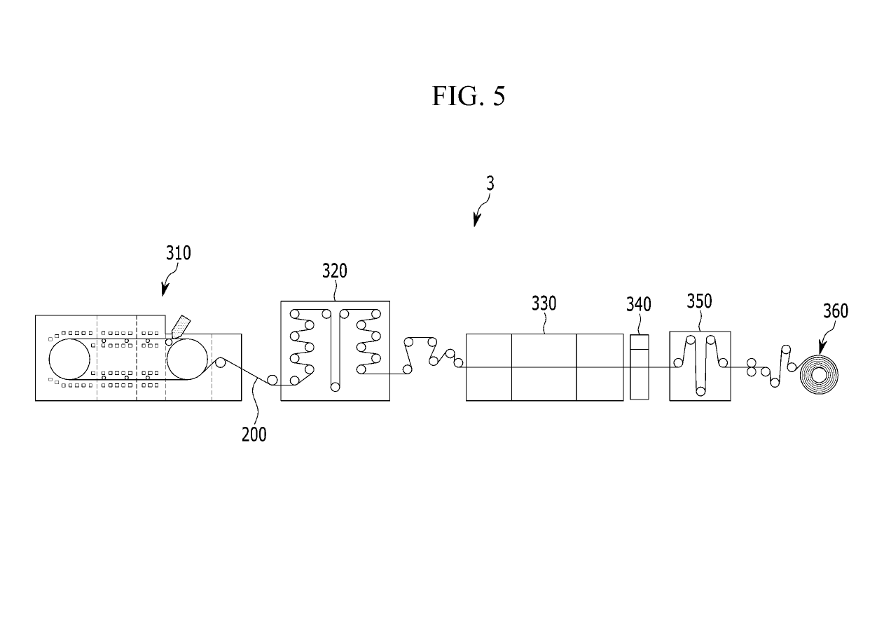

Next, an apparatus of stretching a polymer film and a stretching method using the apparatus according to embodiments is described in further detail with reference to FIG. 5 to FIG. 12.

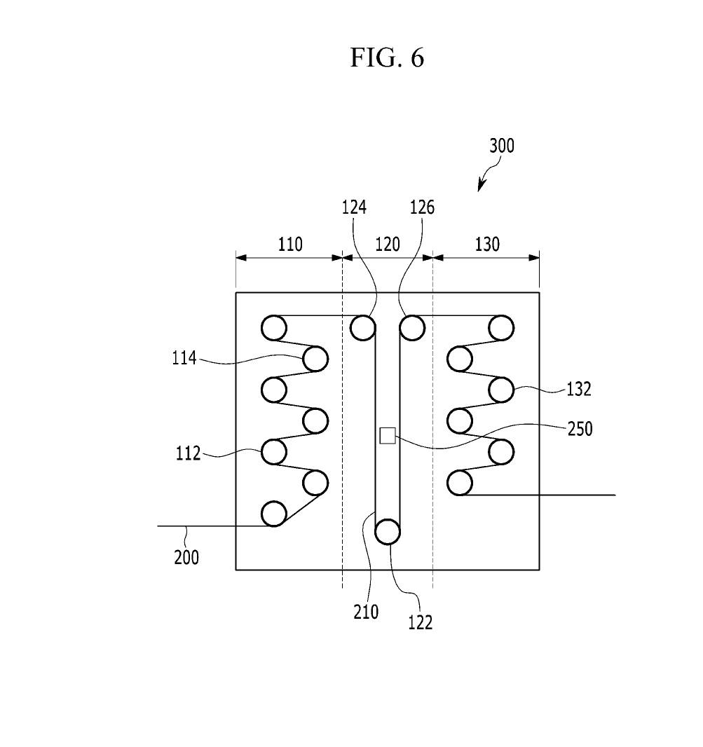

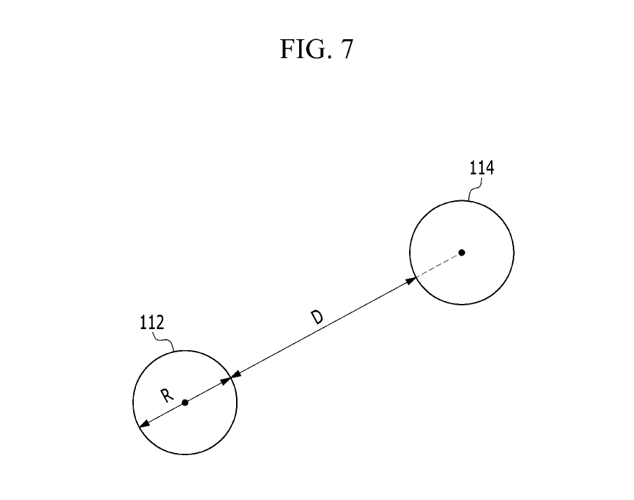

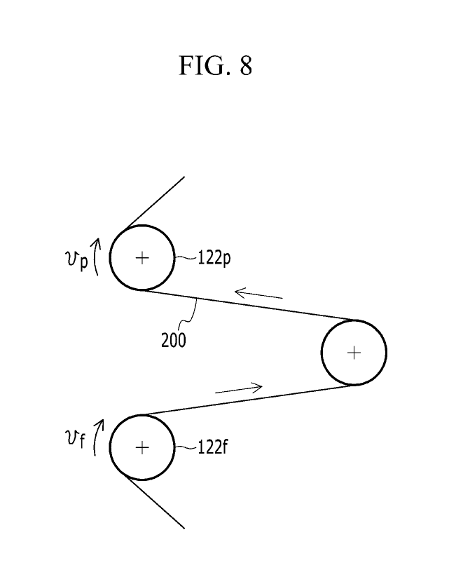

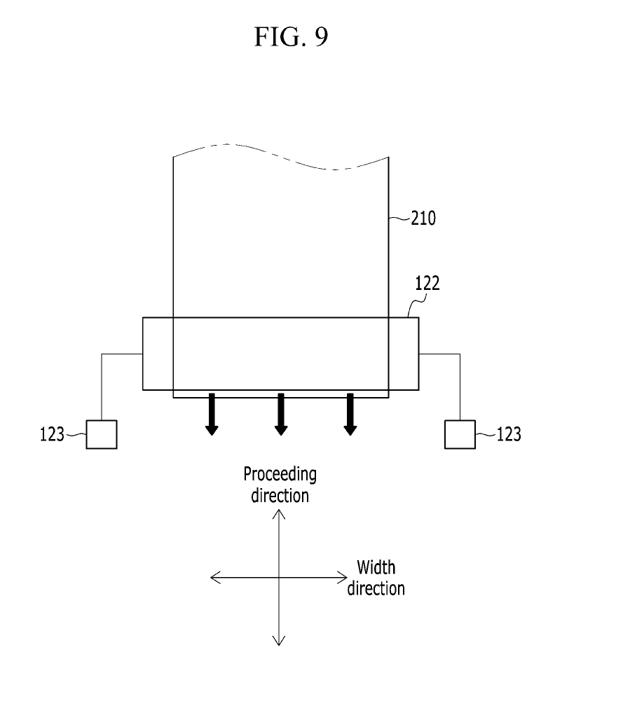

FIG. 5 is a schematic view of an embodiment of an apparatus for stretching a polymer film, FIG. 6 is a schematic front view of an embodiment of a second dryer in the apparatus of stretching a polymer film, FIG. 7 and FIG. 8 are a schematic diagrams illustrating an embodiment of a structure and operation of rollers in a first zone of the second dryer, and FIG. 9 to FIG. 12 are schematic diagrams illustrating operation of a moving roller in the second dryer.

Referring to FIG. 5, an embodiment of an apparatus 3 for stretching a polymer film may include a first dryer 310, a second dryer 320, a tenter or stretcher 330, a thickness gauge 340, a third dryer 350, and a winder 360, which are arranged in series like the stretching apparatus 1 shown in FIG. 2. The first dryer 310, the tenter 330, the thickness gauge 340, the third dryer 350, and the winder 360 may have structures similar to structures of the first dryer 10, the tenter 30, the thickness gauge 40, the third dryer 50, and the winder 60 of the stretching apparatus 1 shown in FIG. 2 and FIG. 3.

The second dryer 320 of the stretching apparatus 3 according to an embodiment may have a structure different from the second dryer 20 of the stretching apparatus shown in FIG. 2.

Referring to FIG. 6, the second dryer 320 according to an embodiment may be divided into a first zone 110, a second zone 120, and a third zone 130. A polymer film 200 may enter into the first zone 110, may pass through the second zone 120, and may reach the third zone 130 to go out of the second dryer. Almost all amount of a solvent included in the polymer film 200 may be evaporated while passing through the second dryer 320.

According to an embodiment, the temperatures of the zones 110, 120, and 130 may rise gradually from the first zone 110, to the third zone 130 along the proceeding direction of the polymer film 200. For example, T1≦T2≦T3 and T1<T3 when the temperature of the first zone 110 is denoted by T1, the temperature of the second zone 120 is denoted by T2, and the temperature of the third zone 130 is denoted by T3. However, the relation between the temperatures of the zones 110, 120, and 130 may be differently determined.

According to an embodiment, the temperature in each of the zones 110, 120, and 130 may be uniform. For example, the temperature T1 in the first zone 110 may be about 100° C. to about 150° C., the temperature T2 in the second zone 120 may be about 120° C. to about 160° C., and the temperature T3 in the third zone 130 may be about 120° C. to about 160° C. However, the temperatures of the zones 110, 120, and 130 may be given otherwise.

In this way, several temperature zones may be established along the proceeding direction of the polymer film 200 and the temperatures may increase gradually or stepwise manner such that the deformation or the distortion of the polymer film 200 during the drying may be decreased.

A plurality of rollers 112, 114, 122, 124, 126, and 132 may be disposed in each of the zones 110, 120, and 130 of the second dryer 320. The rollers 112, 114, 122, 124, 126, and 132 may be configured to move the polymer film 200.

The rollers 112 and 114 in the first zone 110 may be arranged in a zigzag along a vertical direction. According to an embodiment, the rollers 112 and 114 may be arranged in two rows in the vertical direction. One of the two rows may include a plurality of driving rollers 112, and the other of the two rows may include a plurality of idle rollers 114.

The driving rollers 112 may be closer to an entrance of the polymer film 200 while the idle rollers 114 may be farther to the entrance. The vertical positions of the driving rollers 112 and the idle rollers 114 may be different from each other, and the polymer film 200 may start from a bottom to move upward and may alternately pass through the driving rollers 112 and the idle rollers 114.

The zigzag arrangement of the rollers 112 and 114 may increase the staying duration of the polymer film 200 in the second dryer 320 to slow the temperature variation of the polymer film 200, thereby reducing the deformation of the polymer film 200.

Referring to FIG. 7, according to an embodiment, a diameter R of each of the rollers 112 and 114 may range from about 10 centimeters (cm) to about 20 cm. According to an embodiment, a minimum distance D between two adjacent rollers 112 and 114 in the proceeding direction of the polymer film 200, i.e., the distance between a driving roller 112 and an idle roller 114 adjacent to each other may be equal to or less than about 10 cm. The short distance D between the adjacent rolls 112 and 114 may reduce defects in the polymer film 200 such as overlapping near lateral edges.

The third zone 130 may also include a plurality of rollers 132 including driving rollers and idle rollers like the first zone 110, which may be arranged in a zigzag. The structure and the arrangement of the rollers 132 in the third zone 130 may be similar to the rollers 112 and 114 in the first zone 110.

The second zone 120 may include a pair of fixed rollers 124 and 126 fixed at an upper portion and a dancer roller or moving roller 122 configured to move up and down. The polymer film 200 from the first zone 110 may pass through the fixed roller 124 closer to the first zone 110, may be rolled around a bottom surface of the moving roller 122, and may pass through the fixed roller's 126 closer to the third zone 130. Thereafter, the polymer film 200 may move toward the third zone 130.

The second zone 120 may further include a sensor 250 configured to detect a position of the moving roller 122.

While the polymer film 200 moves from the first zone 110 toward the third zone 130, the polymer film 200 may experience tension by the rollers, for example, the driving rollers 112, and the tension may stretch the polymer film 200 in the proceeding direction of the polymer film 200 to some a degree. The stretching ratio of the polymer film 200 may be changed depending on an amount of the tension, and a factor affecting the amount of the tension may be a rotating speed of the driving rollers 112.

According to an embodiment, the rotating speed of each of the driving rollers 112 in the first zone 110 may be different from one another. For example, the rotating speeds of the driving rollers 112 may decrease in the proceeding direction of the polymer film 200. In this way, the tension applied to the polymer film 200 by the rotation of the driving rollers 112 may be reduced.

For example, referring to FIG. 8, when a preceding driving roller 112p disposed preceding to a following driving roller 112f in the proceeding direction of the polymer film 200 has a rotating speed vₚ greater than a rotating speed v_{f} of the following driving roller 112f, a portion of the polymer film 200 disposed between the preceding driving roller 112p and the following driving roller 112f may experience tension and be stretched.

Therefore, the tension applied to the polymer film 200 may be reduced by making the rotating speed vₚ of the preceding driving roller 112p less than the rotating speed v_{f} of the following driving roller 112f, thereby reducing the stretching of the polymer film 200.

In the third zone 130, the rollers 132 may apply tension to the polymer film 200. The polymer film 200 stretched under the low temperature of the first zone 110 may be contracted under the high temperature of the third zone 130, and thus the polymer film 200 may experience compressive stress.

Since the structure and the arrangement of the rollers 132 in the third zone 130 is similar to those in the first zone 110, the tension and the stress applied to the polymer film 200 in the third zone 130 may be also reduced as described in the first zone 110.

According to an embodiment, a plurality of tension gauges (not shown) configured to measure the tension applied to the polymer film 200 may be disposed in the first zone 110 and/or the third zone 130. The tension gauge may measure, for example, the proceeding speed of the polymer film 200, and the tension applied to the polymer film 200 may be calculated from the measured proceeding speed.

As described above, the polymer film 200 may suffer tension both in the first zone 110 and the third zone 130. The strength of the tension in the first zone 110 may be substantially the same as the strength of the tension in the third zone 130, but the tension strengths may be different from each other. The difference in the strength of the tension between the two zones 110 and 130 may cause deformation of the polymer film 200, and, in the worst case, the polymer film 200 may be torn.

The second zone 120 may reduce the deformation of the polymer film 200 due to the tension difference between the first zone 110 and the third zone 130.

In the second zone 120, the polymer film 200 may have an extra drooping portion 210 that is disposed between the fixed roller 124 closer to the first zone 110 and the fixed roller 126 closer to the third zone 130. For example, when the tension in the third zone 130 increases abruptly such that an input speed of the polymer film 200 from the first zone 110 is greater than an output speed of the polymer film 200 toward the third zone 130, the extra portion 210 of the polymer film 200 may be shortened to absorb the tension change.

The moving roller 122, using the weight of the moving roller 122 itself, may make the tension applied to the polymer film 200 both in the proceeding direction and in a direction perpendicular to the proceeding direction, i.e., a width direction of the polymer film 200 such that the tension deviation on the extra portion 210 of the polymer film 200 may be decreased. In addition, the moving roller 122 may move up and down to respond to the length variation of the extra portion 210.

For example, referring to FIG. 9, the moving roller 122 may push down the extra portion 210 of the polymer film 200 by its own weight, and when a shape and a weight distribution of the moving roller 122 are uniform, the pushing force along a direction of the central axis of the moving roller 122 or along the width direction of the polymer film 200 may be uniform. Therefore, the moving roller 122 may reduce the tension deviation in the width direction of the polymer film 200.

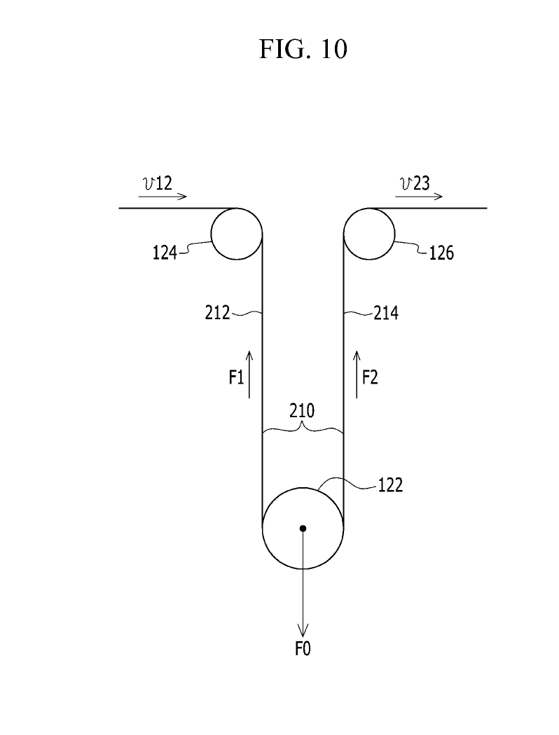

Referring to FIG. 10, when the tensions in the first zone 110 and in the third zone 130 are substantially the same, a speed v12 of the polymer film 200 moving from the first zone 110 to the second zone 120 may be substantially the same as a speed v23 of the polymer film 200 moving from the second zone 120 to the third zone 130. Therefore, the length of the extra portion 210 of the polymer film 200 may be maintained substantially constant, and the position of the moving roller 122 may be fixed.

At this time, the tension F1 applied to a left portion 212 of the extra portion 210 of the polymer film 200 disposed left to the moving roller 122 may be balanced with the tension F2 applied to a right portion 214 of the extra portion 210 disposed right to the moving roller 122. For example, if it is assumed that the polymer film 200 stops, each of the tensions F1 and F2 respectively applied to the left portion 212 and the right portion 214 of the extra portion 210 of the polymer film 200 may be substantially equal to about a half of a weight F0 of the moving roller 122.

Since the tensions F1 and F2 applied to the polymer film 200 depend on the weight F0 of the moving roller 122, the strengths of the tensions F1 and F2 may be controlled by adjusting the weight F0 of the moving roller 122. For example, a heavy moving roller 122 may increase the tensions F1 and F2 applied to the polymer film 200, and on the contrary, a light moving roller 122 may decrease the tensions F1 and F2 applied to the polymer film 200.

However, since the change of the weight F0 of the moving roller 122 itself may not be inconvenient in a practical manner, an example shown in FIG. 9 may include a pair of small weights 123 that may be configured to be hung at respective ends of the moving roller 122 and to be removed from the moving roller 122 in order to obtain expected strengths of the tensions F1 and F2. According to an embodiment, the weights 123 at respective ends of the moving roller 122 may have different weights or one of the weights 123 may be omitted in order to reduce the tension unbalance of the polymer film 200 in the width direction. According to an embodiment, load cells configured to measure the pushing force of the moving roller 122 may be provided at both ends of the moving roller 122, and the deviation of the tensions may be calculated from the measurement.

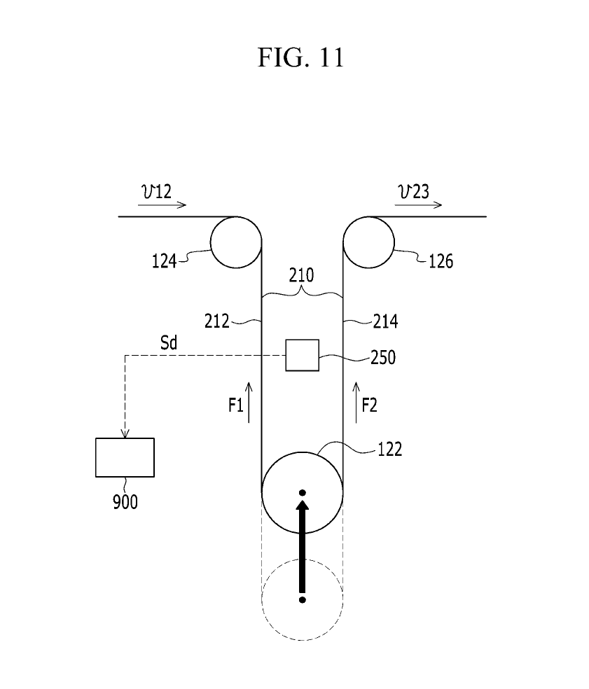

Referring to FIG. 11, for example, when the tension drawing the polymer film 200 in the third zone 130 is increased, and the speed v23 of the polymer film 200 moving toward the third zone 130 becomes abruptly greater than the speed v12 of the polymer film 200 moving from the first zone 110, the extra portion 210 of the polymer film 200 may be shortened. The moving roller 122 configured to move up and down may move upward in response to the length reduction of the extra portion 210.

When the difference in the tension between the first zone 110 and the third zone 130 and the resulting difference in the speeds v12 and v23 lasts for a long time, the shrinkage of the extra portion 210 may continue, and at last the extra portion 210 may disappear. Therefore, the tension difference between the first zone 110 and the third zone 130 may be rapidly resolved such that a minimum length of the extra portion 210 is provided. Since one of factors affecting the tensions in the first zone 110 and the third zone 130 may be a rotational speed of the driving rollers 112 and 132 in the first zone 110 and the third zone 130 as described above, the tension unbalance may be reduced or resolved by adjusting the rotational speed of the driving rollers 112 and 132.

Since the moving roller 122 moves upward when the extra portion 210 of the polymer film 200 is shortened, the length of the extra portion 210 of the polymer film 200 may be calculated by detecting the position of the moving roller 122 using the sensor 250.

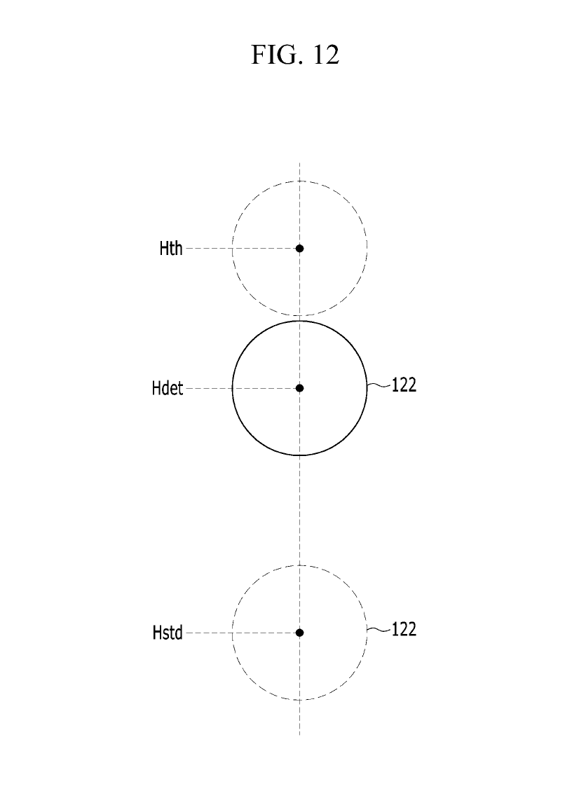

Referring to FIG. 12, the moving roller 122 that maintains at a reference height in a normal state may move upward when the length of the extra portion 210 is decreased. If it is assumed that the extra portion 210 of the polymer film 200 may become too short such that the polymer film 200 be deformed when the moving roller 122 exceeds a limit height Hstd, the sensor 250 may detect the moving roller 122 when the moving roller 122 reaches a detection height Hstd located lower than the limit height Hstd.

Referring to FIG. 11 again, the sensor 250 according to an embodiment may detect the moving roller 122 and may generate a sensing signal Sd corresponding thereto when the moving roller 122 reaches the detection height Hstd. The sensor 250 may be connected to an external device 900 such as a control device, a display device, or an alarm device, and may send the sensing signal Sd to the external device 900.

The external device 900 after receiving the sensing signal Sd may directly control the driving rollers 112 and 132 in the first zone 110 and/or the third zone 130, or may provide visual or audio information of the corresponding situation for a user to control the driving rollers 112 and 132.

The secondary dryer 320 according to embodiments may increase the solvent evaporation to reduce the residual amount of the solvent, and in addition, may reduce the deformation of the polymer film 200 that may be produced in the process as well as maintaining the value of in-plane retardation of the polymer film 200.

### EXAMPLES

Example embodiments and comparative embodiments of a polyimide film are described in further detail.

As described with reference to FIG. 2 to FIG. 4, a polyimide film is extruded, first dried, and stripped using a first dryer 10, second dried using a second dryer 20, stretched in a width direction using a tenter 30, and third dried using a third dryer 50 to complete the polyimide film.

The temperature and the stretching ratio of the second dryer 20 and an amount of a residual solvent of the polyimide film are varied, and an optical phase retardation of the completed polyimide film is measured.

The solvent is dimethylacetamide (“DMAc”), and a maximum temperature of the first dryer 10 is about 140° C. In the tenter 30, the temperature of the first zone Z31 is about 140° C., and the stretching ratio in the first zone Z31 is about 10%. The temperature of the second zone Z32 is about 224° C., and the stretching ratio in the second zone Z32 about −1%. The temperature of the third zone Z33 is about 256° C., and the stretching ratio in the third zone Z33 is about 0%. A thickness of the polyimide film after stretched in the tenter 30 is about 40 μm, and the temperature of the third dryer 50 is about 300° C. The optical phase retardation of the completed polyimide film is measured by using AXOSCAN (produced by AXOMETRICS, INC.).

Table 1 shows experimental conditions and results.

TABLE 1

| | Second dryer | | | Retardation after | |
|---|---|---|---|---|---|
| | Temper- | | Residual | stretching | |
| | atures | Stretching | Solvent | Average | Deviation |
| | (° C.) | Ratio | (wt %) | (nm) | (nm) |
| Example | 200 | 0.970 | 4 | 5 | 5 |
| Embodiment 1 | | | | | |
| Example | 200 | 0.985 | 5 | 8 | 6 |
| Embodiment 2 | | | | | |
| Example | 200 | 0.965 | 7 | 7 | 5 |
| Embodiment 3 | | | | | |
| Example | 190 | 0.975 | 8 | 8 | 5 |
| Embodiment 4 | | | | | |
| Example | 180 | 0.975 | 10 | 7 | 5 |
| Embodiment 5 | | | | | |
| Example | 180 | 0.995 | 12 | 9 | 6 |
| Embodiment 6 | | | | | |
| Comparative | 40 | — | 16 | 15 | 12 |
| Embodiment 1 | | | | | |
| Comparative | 25 | — | 18 | 18 | 15 |
| Embodiment 2 | | | | | |
| Comparative | 180 | 0.945 | 12 | — | — |
| Embodiment 3 | | | | | |
| Comparative | 180 | 1.020 | 12 | 54 | 14 |
| Embodiment 4 | | | | | |

As shown in Table 1, in Example Embodiments 1 to 5 where the temperature of the second dryer 20 is about 180° C. to about 200° C., the stretching ratio is about 0.970 to about 0.985, and the amount of the residual solvent is equal to or less than about 10 wt %, the retardation after stretching in the tenter 30 is equal to or less than about 8 nm, and the deviation of the retardation is equal to or less than about 6 nm, both of which are low.

In Example Embodiment 6 where the temperature of the second dryer 20 is about 180° C., the stretching ratio is about 0.995, and the amount of the residual solvent is equal to or less than about 12 wt %, the retardation after stretching in the tenter 30 is equal to or less than about 9 nm, and the deviation of the retardation is equal to or less than about 6 nm, both of which are relatively low.

In Comparative Example 1 and Comparative Example 2 where the temperature of the second dryer 20 is lowered equal to or lower than about 100° C. The second dry is performed at about 40° C. in Comparative Example 1 and at a room temperature of about 25° C. in Comparative Example 2. The amount of the residual solvent in Comparative Example 1 is about 16 wt %, and the amount of the residual solvent in Comparative Example 2 about 18 wt %, which are high. The retardation after stretching in the tenter 30 is equal to or higher than about 15 nm, and the deviation of the retardation is equal to or higher than about 12 nm, which are almost twice the values in Example Embodiment 1 to 6.

In Comparative Example 3 and Comparative Example 4, the temperature of the second dryer 20 is about 180° C., and the amount of the residual solvent is about 12 wt %, which are similar to Example Embodiment 6. However, the stretching ratio in Comparative Example 3 is about 0.945 that is lower than Example Embodiment 6, and the stretching ratio in Comparative Example 4 is about 1.020 that is higher than Example Embodiment 6. The retardation after stretching in the tenter 30 in Comparative Example 4 is very high (about 54 nm), and the deviation is high (about 14), too. In Comparative Example 3, the polyimide film droops too much to perform subsequent processes.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing a polyimide film, the method comprising:
extruding a polyimide film comprising a polyimide and a solvent;
first drying the extruded polyimide film;
stripping the first-dried polyimide film;
second drying the stripped polyimide film to remove a residual solvent in the polyimide film; and
stretching the second-dried polyimide film in a width direction,
wherein an amount of the residual solvent in the second-dried polyimide film is equal to or less than about 10 weight percent.

2. The method of claim 1, wherein the amount of the residual solvent in the second-dried polyimide film is equal to or less than about 5 weight percent.

3. The method of claim 1,
wherein the second drying comprises stretching the stripped polyimide film in a length direction which is perpendicular to the width direction.

4. The method of claim 3, wherein a stretching ratio of the stretching in the length direction ranges from about 0.95 to about 1.0.

5. The method of claim 4, wherein the stretching ratio of the stretching in the length direction ranges from about 0.965 to about 0.995.

6. The method of claim 1, wherein a temperature in the second drying is greater than a maximum temperature in the first drying and less than a maximum temperature in the stretching.

7. The method of claim 6, wherein
the maximum temperature in the first drying ranges from about 100° C. to about 220° C.,
the temperature in the second drying ranges from about 150° C. to about 250° C., and
the maximum temperature in the stretching ranges from about 200° C. to about 400° C.

8. The method of claim 1, wherein an amount of a residual solvent in the first dried polyimide film ranges from about 15 weight percent to about 30 weight percent.

9. The method of claim 1, further comprising:
third drying the stretched polyimide film.

10. The method of claim 1, wherein a value of an optical phase retardation of the stretched polyimide film is equal to or less than about 10 nanometers, and a deviation of the optical phase retardation of the stretched polyimide film is equal to or less than about 10 nanometers.

11. A method of manufacturing a polyimide film, the method comprising:
extruding a polyimide film comprising a polyimide and a solvent;
first drying the extruded polyimide film;
stripping the first-dried polyimide film;
second drying the stripped polyimide film to remove a residual solvent in the polyimide film; and
stretching the second-dried polyimide film in a width direction, wherein the second drying comprises:
stretching the stripped polyimide film in a length direction, wherein a stretching ratio of the stretching in the length direction ranges from about 0.95 to about 1.0, and
an amount of the residual solvent in the second-dried polyimide film is equal to or less than about 12 weight percent.

12. The method of claim 11, wherein the stretching ratio of the stretching in the length direction ranges from about 0.965 to about 0.995.

13. The method of claim 12, wherein a temperature in the second drying is greater than a maximum temperature in the first drying and less than a maximum temperature in the stretching.

14. The method of claim 13, wherein
the maximum temperature in the first drying ranges from about 100° C. to about 220° C.,
the temperature in the second drying ranges from about 150° C. to about 250° C., and
the maximum temperature in the stretching ranges from about 200° C. to about 400° C.

15. The method of claim 12, wherein an amount of a residual solvent in the first dried polyimide film ranges from about 15 weight percent to about 30 weight percent.

16. The method of claim 12, further comprising:
third drying the stretched polyimide film.

17. The method of claim 12, wherein a value of an optical phase retardation of the stretched polyimide film is equal to or less than about 10 nanometers, and a deviation of the optical phase retardation of the stretched polyimide film is equal to or less than about 10 nanometers.

18. An apparatus for stretching a polymer film, the apparatus comprising:
a first dryer configured to dispose a polymer film on a belt, to dry the polymer film, and to strip the polymer film from the belt;
a second dryer configured to re-dry the polymer film from the first dryer to reduce an amount of a residual solvent in the polymer film; and
a stretching unit configured to stretch the polymer film from the second dryer in a width direction of the polymer film.

19. The apparatus of claim 18, wherein the second dryer comprises:
a first zone including a plurality of first rollers configured to move the polymer film;
a second zone adjacent to the first zone; and
a third zone adjacent to the second zone and including a plurality of second rollers configured to move the polymer film,
wherein the polymer film passes through the first zone, the second zone, and the third zone in sequence.

20. The apparatus of claim 19, wherein
the first rollers are arranged in a zigzag in the first zone, and
the second rollers are arranged in a zigzag in the third zone.

21. The apparatus of claim 20, wherein the first rollers comprise:
a plurality of rotatable driving rollers arranged in a vertical direction; and
a plurality of idle rollers spaced apart from the driving rollers in a horizontal direction, arranged in the vertical direction, and having vertical positions different from vertical positions of the driving rollers, and
wherein the polymer film contacts the driving rollers and the idle rollers in an alternate manner to move in a vertical direction.

22. The apparatus of claim 21, wherein the driving rollers comprise:
a first driving roller; and
a second driving roller preceding the first driving roller in a proceeding direction of the polymer film, and
wherein a rotating speed of the second driving roller is smaller than a rotating speed of the first driving roller.

23. The apparatus of claim 19, wherein the second zone comprises a moving roller configured to move in a vertical direction,
the polymer film comprises an extra portion drooping in the second zone,
the extra portion of the polymer film contacting a bottom surface of the moving roller and pressed by a weight of the moving roller, and
the moving roller moves in the vertical direction based on a length of the extra portion of the polymer film.

24. The apparatus of claim 23, wherein the second zone further comprises a sensor configured to detect a vertical position of the moving roller.

25. The apparatus of claim 19, wherein a minimum distance between two adjacent first rollers in a proceeding direction of the polymer film is equal to or less than about 10 centimeters.

26. The apparatus of claim 19, further comprising a third dryer configured to dry the polymer film from the stretching unit to remove the residual solvent in the polymer film.

27. The apparatus of claim 18, further comprising a thickness gauge configured to measure a thickness of the polymer film from the stretching unit.

28. The apparatus of claim 18, wherein the stretching unit comprises a tenter.
